(19) United States
(12) Patent Application Publication
(10) Pub. No.: US 2007/0015488 A1
(43) Pub. Date: Jan. 18, 2007

(54) Broadcasting program-reproducing apparatus

(75) Inventor: Masahiro Takayama, Tokyo (JP)

Correspondence Address: PILLSBURY WINTHROP SHAW PITTMAN, LLP, P.O. BOX 10500, MCLEAN, VA, 22102, US

(73) Assignee: KABUSHIKI KAISHA TOSHIBA, Tokyo (JP)

(21) Appl. No.: 11/429,952

(22) Filed: May 9, 2006

(30) Foreign Application Priority Data
Jul. 15, 2005 (JP) 2005-207796

(51) Int. Cl. H04Q 7/20

(52) U.S. Cl. 455/403

(57) ABSTRACT

The invention aims at providing a broadcasting program-reproducing apparatus which is capable of accumulating data on pieces of music in a recorded musical program and of reproducing only a desired piece of music. A broadcasting program-reproducing apparatus (1) according to the invention can store management information on pieces of music in a program concurrently with recording of data on the program, recognize to which positions in the program start time and end time of each piece of music correspond, and extract and reproduce only one piece of music contained in one sound file.

The present application is based on Japanese patent application No. 2005-207796, the entire contents of which are incorporated herein by reference.

### BACKGROUND OF THE INVENTION

1. Field of the Invention

The present invention relates to a broadcasting program-reproducing apparatus, and more particularly to an S-band satellite digital broadcasting program-reproducing apparatus which is capable of managing data for each piece of music within a musical program which is received and recorded.

2. Description of Related Art

A television/radio broadcasting program-reproducing apparatus which is easy to carry and a broadcasting system aiming at such a portable broadcasting program-reproducing apparatus have been developed, and dedicated broadcasting programs have also started to be broadcasted. In order to make such a broadcasting program-reproducing apparatus easy to carry, the broadcasting program-reproducing apparatus has been naturally miniaturized. Despite of such miniaturization, the broadcasting program-reproducing apparatus can reproduce image and sound of high quality in accordance with the advance of technology.

In addition, a picture/sound recording function is also installed in the portable broadcasting program-reproducing apparatus. Thus, even when a program which is broadcasted cannot be seen and listened on real-time basis, the picture recording and the sound recording are performed, whereby the program thus recorded can be seen and listened on later days. In particular, since a data compression system having a high regulating ratio is used for the broadcasting data in the broadcasting system concerned, the broadcasting data therein can be reduced to a small data capacity. Thus, even when no large-capacity recording medium is used, many programs can be recorded.

In the case where many programs are recorded, a system for efficiently selecting desired one from among the recorded programs is required. This case is similar to the case where a desired piece of music is selected from a storage medium in which a plurality of musical data are recorded. In this case, a method has been invented such that when data is duplicated from a music CD to a storage medium such as an HDD, a play list of pieces of music to be duplicated is generated, thereby generating a database of pieces of music in the storage medium concerned. This is disclosed in the Japanese Patent Kokai No. 2005-85303.

With respect to the picture and sound recordings of a program, at present, a simple comment about the program contents can be recorded in the form of data by utilizing an Electronic Program Guide (EPG). Hence, the program desired to be reproduced becomes easy to retrieve.

However, when a musical program is recorded from satellite broadcasting, the overall musical program constitutes one sound data file. For this reason, even if it is desired that a piece of music contained in a certain musical program is selected, the overall musical program having the piece of music concerned contained therein is necessarily selected. Thus, in order to reproduce only the piece of music concerned, a rapid feed function and a rewind function must be used.

Or, even when the information on the overall program exists, information on each piece of music contained in the program cannot be acquired. Thus, what pieces of music contained in the program are is unknown unless the program is actually reproduced.

### SUMMARY OF THE INVENTION

In the light of the foregoing, it is an object of the present invention to provide a broadcasting program-reproducing apparatus which is capable of accumulating data on pieces of music in a recorded musical program and of reproducing only a desired piece of music.

In order to attain the above-mentioned object, according to an aspect of the present invention, there is provided a broadcasting program-reproducing apparatus including: a receiving portion for receiving a broadcasting program of an image or a sound, and management information corresponding to events constituting the broadcasting program; a storing portion for storing therein the broadcasting program and the management information; a determining portion for determining start positions and end positions of the events in the storing portion in accordance with the management information stored in the storing portion; a list-generating portion for extracting a predetermined event from the events in the broadcasting program in accordance with the start positions and the end positions of the events to generate a play list; and a reproducing portion for reproducing the predetermined event thus extracted in accordance with the play list.

The receiving portion may receive the broadcasting program containing music as the event, and the management information containing at least one piece of information on names of the music, artist names, and broadcasting time.

The reproducing portion may extract music of a predetermined artist name selected from the artist names in accordance with a plurality of broadcasting programs and a plurality of pieces of management information, and may reproduce the music thus extracted.

The storing portion may include a first file in which the broadcasting program is stored, and a second file in which the management information is stored.

The determining portion may shift the start positions of the event forward or rearward by a predetermined position.

According to the present invention, only a desired piece of music can be selected from the data on the broadcasting program having a plurality of pieces of music collected therein.

### BRIEF DESCRIPTION OF THE DRAWINGS

FIG. 1 is a view showing a schematic construction of a receiving system according to an embodiment of the present invention;

FIG. 2 is a block diagram showing an internal configuration of a broadcasting program-reproducing apparatus according to the embodiment of the present invention;

FIG. 3 is a plan view showing details of an operation portion shown in FIG. 1;

FIG. 4 is a diagram showing correspondence between broadcasting contents contained in a sound file of a broadcasting program recorded with the broadcasting program-reproducing apparatus according to the embodiment of the present invention, and management information of the broadcasting program;

FIGS. 5A and 5B are respectively a diagram showing a display example of a list of programs recorded with the broadcasting program-reproducing apparatus according to the embodiment of the present invention, and a diagram showing a display example of a musical name list contained in a selected program;

FIG. 6 is a diagram showing a situation in which desired music is selected from a plurality of broadcasting program data;

FIGS. 7A and 7B are respectively a diagram showing a display example of an image of a retrieval picture during retrieval of music, and a diagram showing a display example of an image of a play list after the retrieval of music;

FIGS. 8A, 8B and 8C are respectively diagrams showing a situation in which an error between time on management data and actual broadcasting time is adjusted; and

FIG. 9 is a diagram showing a display example of an image during adjustment of start time.

### DETAILED DESCRIPTION OF PREFERRED EMBODIMENTS

Hereinafter, a preferred embodiment of the present invention will be described in detail with reference to the accompanying drawings.

(Construction of System)

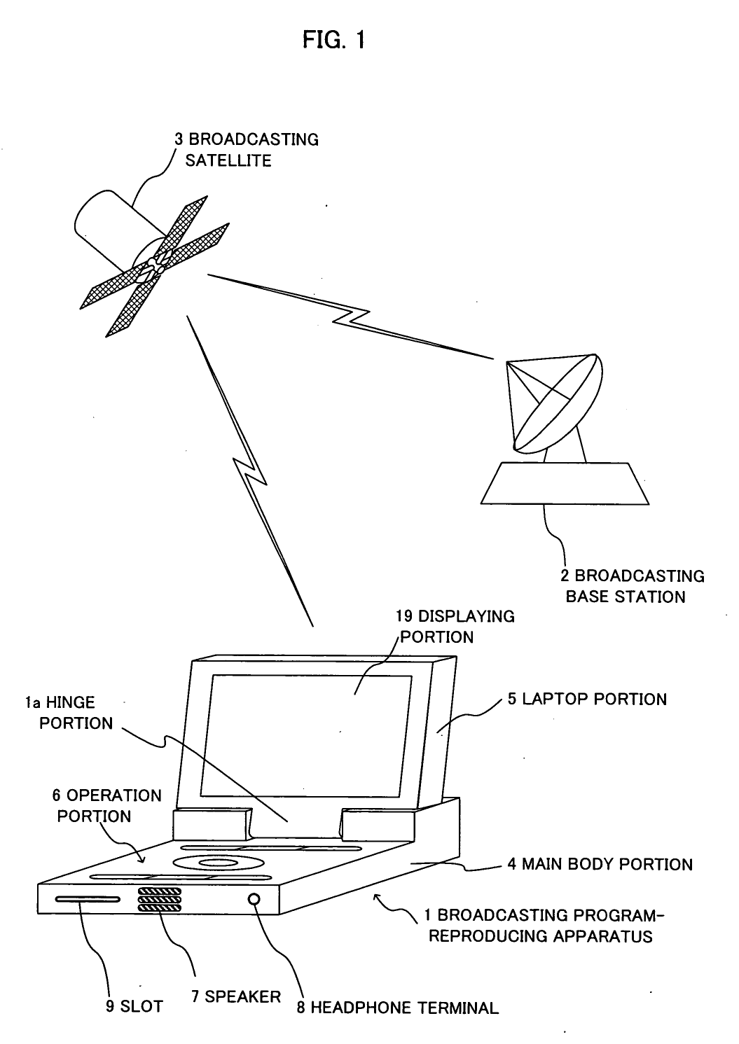

FIG. 1 shows a schematic construction of a receiving system according to an embodiment of the present invention. The receiving system is schematically constituted by a broadcasting base station 2 which is installed on the ground and which can transmit a plurality of digital broadcastings such as a television program broadcasting and a radio program broadcasting, and a broadcasting program-reproducing apparatus 1 which receives a broadcasting electric wave from the broadcasting base station 2 via a broadcasting satellite 3 located in a space.

It should be noted that while FIG. 1 shows an example when the satellite broadcasting is received, the broadcasting program-reproducing apparatus 1 of the present invention is not limited thereto. Thus, one which receives ground wave broadcastings, one which receives broadcastings through a transmission medium such as a cable, one which receives bidirectionally broadcastings, or the like may also be adopted.

With the broadcasting program-reproducing apparatus 1, a user can select a program which is to his/her taste from among a plurality of broadcastings, and can see and listen to the selected program. The broadcasting program-reproducing apparatus 1 includes a main body portion 4 having an antenna, an electronic circuit and the like built therein, and a laptop portion 5 which is provided closeably in an upper portion of the main body portion 4 through a hinge portion 1a.

The main body portion 4 is provided with an operation portion 6 including various kinds of switches on its an upper surface. Also, the main body portion 4 is provided with a speaker 7, a headphone terminal 8, and a slot into which a memory card as will be described later is inserted on its front. Incidentally, the speaker 7 and the headphone terminal 8 constitute a sound-outputting portion 21.

The laptop portion 5 includes a displaying portion 19 such as a liquid crystal display device, or an organic EL display device.

When the user desires to see and listen to a television program, the display portion 19 displays thereon a program image, and the sound outputting portion outputs a program sound. On the other hand, when the user desires to listen to a radio program, the sound-outputting portion 21 outputs a program sound, and at the same time, the displaying portion 19 displays thereon information or the like on the contents of the program and pieces of music being broadcasted. Whether a television broadcasting or a radio broadcasting is selected is determined by operating the operation portion 6.

(Internal Configuration of Broadcasting Program-Reproducing Apparatus 1)

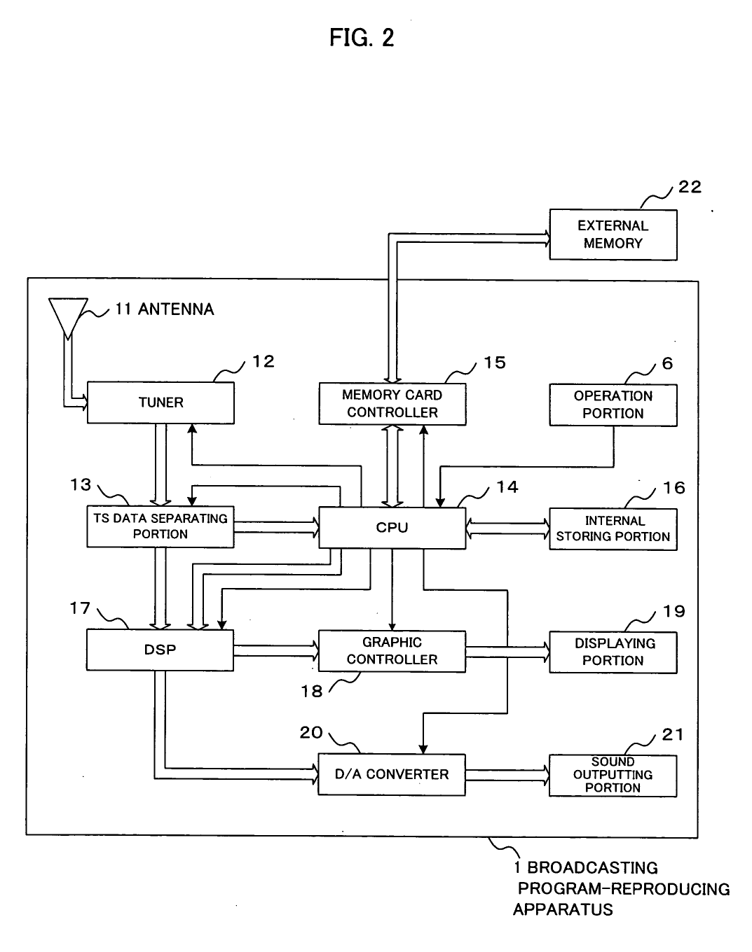

FIG. 2 is a block diagram showing an internal configuration of the broadcasting program-reproducing apparatus 1 according to the present invention.

The broadcasting program-reproducing apparatus 1 includes an antenna 11, a tuner 12, a transport stream (TS) data separating portion 13, a CPU 14, a memory card controller 15, an internal storing portion 16, a digital signal processor (DSP) 17, a graphic controller 18, a displaying portion 19, a D/A converter 20, and a sound outputting portion 21.

The antenna 11 receives thereat a broadcasting electric wave, about a satellite broadcasting program, which is outputted from the broadcasting base station 2 and transmitted via the broadcasting satellite 3. Also, the antenna 11 converts the broadcasting electric wave received thereat into an electrical signal and transmits the resulting electrical signal to the tuner 12.

The tuner 12 selects. necessary data from the satellite broadcasting data transmitted thereto through the antenna 11, and transmits the necessary data thus selected to the TS data separating portion 13.

The TS data separating portion 13 separates the digital broadcasting signal received thereat from the tuner 12 into video/sound data on a program image and a program sound, and management information data such as EPG data and management data. Also, the TS data separating portion 13 transmits the management information data and the video/sound data to the CPU 14 and the DSP 17, respectively.

The CPU 14 manages the control for the functions in the broadcasting program-reproducing apparatus 1. Thus, the CPU 14 transmits signals to the constituent portions to instruct the constituent portions to perform the various kinds of operations, respectively. In addition, the CPU 14 performs the control for the transmission of the data during storage and reading of the received program data in and from the internal storing portion 16 or the like.

The memory card controller 15 controls a memory card or the like as an internal memory 22, and performs the reading and writing of the program data which is recorded with image and sound from and to the external memory 22.

The internal storing portion 16 is used to store a program which the CPU 14 is instructed to execute in order to drive the broadcasting program-reproducing apparatus 1, temporarily store the various kinds of parameters, the management information data, and the like which are used in the program, and store the program data which is recorded with image and sound. More specifically, a ROM, a RAM, an HDD or the like corresponds to the internal storing portion 16.

The DSP 17 executes arithmetic operation processing for the video/sound data which is received from the TS data separating portion 13. Also, the DSP 17 transmits the video data and the sound data to the graphic controller 18 and the D/A converter 20, respectively.

The graphic controller 18 processes the video data received from the DSP 17 so that the displaying portion 19 can display thereon the resulting data. Also, the graphic controller 18 transmits the resulting data to the displaying portion 19.

The displaying portion 19 displays the video data received from the graphic controller 18 on its monitor. The image to be displayed is an image of the television program from the satellite broadcasting, character information on a sound program, information on the apparatus setting for the broadcasting program-reproducing apparatus 1, or the like.

The D/A converter 20 converts the sound data received from the DSP 17 from digital data into analog data. Also, the D/A converter 20 transmits the resulting analog sound data to the sound-outputting portion 21.

The sound-outputting portion 21 convert the analog sound signal received from the D/A converter 20 into the sound and outputs the resulting sound. The sound outputting portion 21 includes an amplifier (not shown), the speaker 7, the headphone terminal 8, and the like.

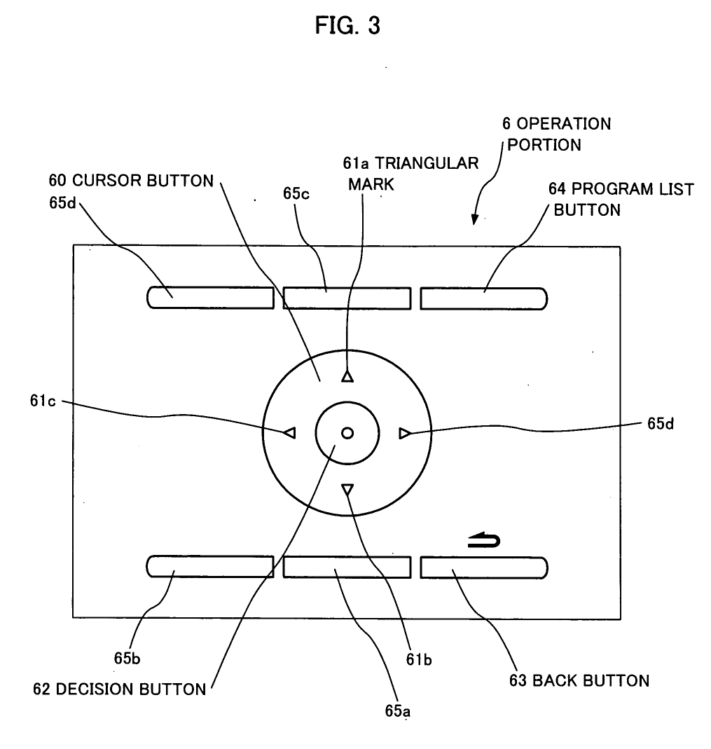

FIG. 3 shows details of the operation portion 6. The operation portion 6 includes a doughnut-like cursor button 60 having triangular marks 61a to 61d provided vertically and horizontally on its surface, a circular decision button 62 provided inside the cursor button 60, a slender back button 63, a program list button 64, and other buttons 65a to 65d. The cursor button 60, the decision button 62, the back button 63, and the program list button 64 will be described later. In FIG. 3, reference numeral 65a designates a stop button for stop of the reproduction of the recorded data, reference numeral 65b designates a button for display of information on a data information service, reference numeral 65c designates a button for display of a memo list recorded in the memory card, and reference numeral 65d designates a quick/setting button for display of a quick menu and a setting menu.

(Operation of Broadcasting Program-Reproducing Apparatus 1)

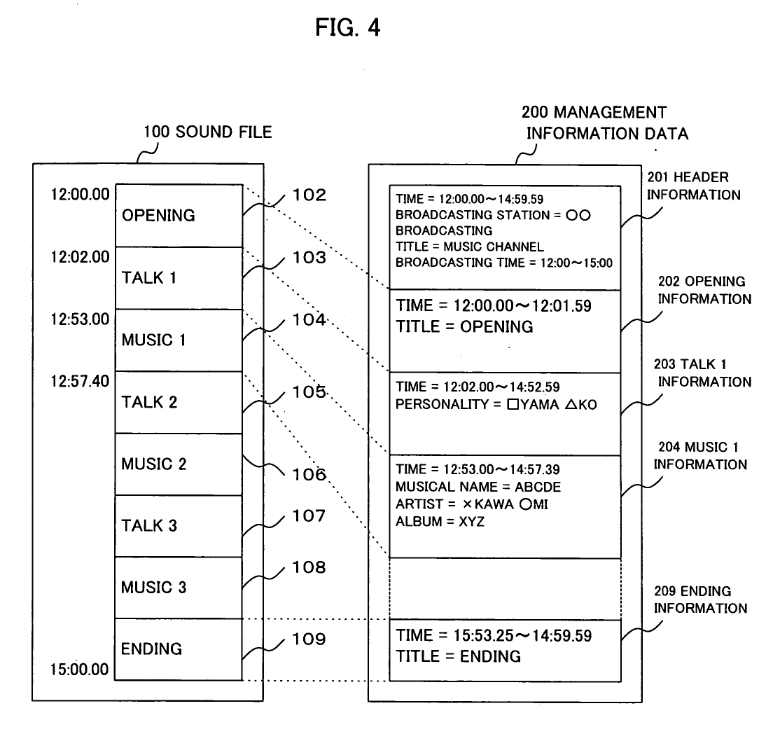

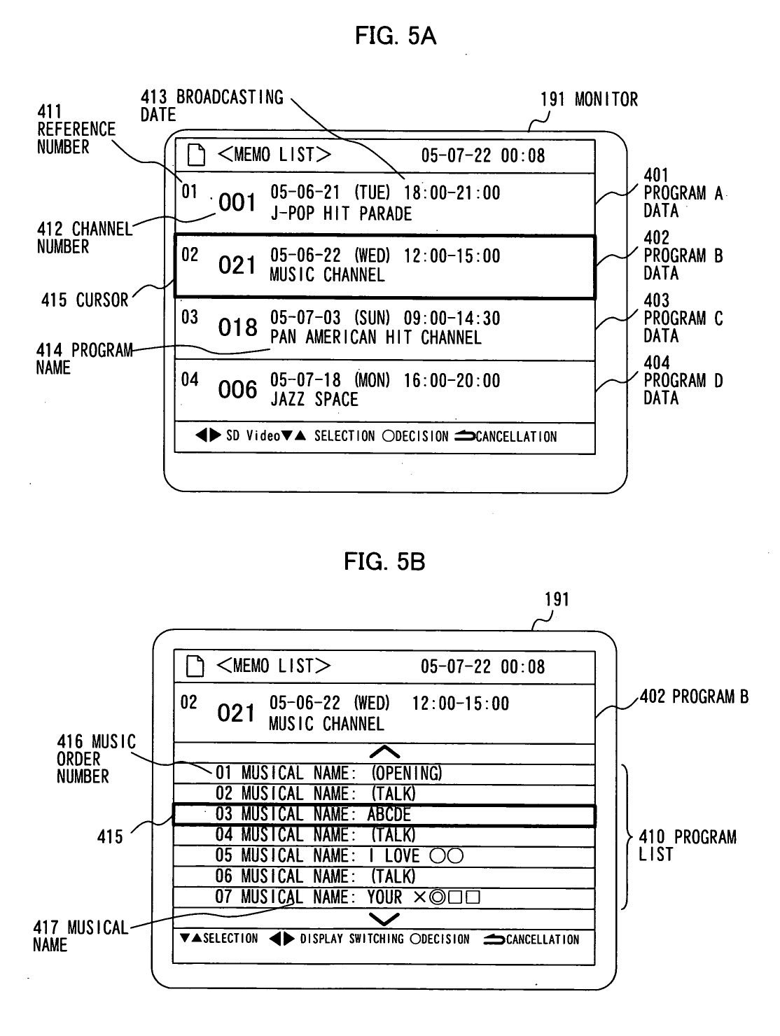

An operation of the broadcasting program-reproducing apparatus 1 according to the present invention will hereinafter be described in detail with reference to FIG. 4, FIGS. 5A and 5B, FIG. 6, and FIGS. 7A and 7B

The feature of the broadcasting program-reproducing apparatus 1 according to the present invention is that management information on the broadcasting contents is recorded concurrently with the sound recording of the radio broadcasting, and data on pieces of music which are broadcasted in the program contained on the management information is retrieved, whereby only the pieces of music to which the user desires to listen can be retrieved and extracted.

FIG. 4 is a diagram showing correspondence between broadcasting contents contained in a sound file of a broadcasting program which is recorded with sound with the broadcasting program-reproducing apparatus 1, and management information of the broadcasting program concerned.

A radio program contained in a sound file 100 is constituted by corners consisting of opening 102, talk 1 (103), music 1 (104), talk 2 (105), music 2 (106), talk 3 (104), music 3 (108), and ending (109).

The sound file 100 is one data file, and the above-mentioned corners are constructed in the form of one data, and thus are not divided. Hence, since a start position of each of the corners is obscure by using only the sound file 100, it cannot be exactly grasped in order to perform the reproduction.

Management information data 200 contains header information 201 as information on the overall radio program, and opening information 202, talk information 203, music 1 information 204, ending information 209, and the like which correspond to the corners, respectively.

The header information 201 contains information on broadcasting time of the overall radio program, a name of a broadcasting station, a program title, and the like. In addition, the management information, on the talk corner, such as the talk information 203 contains information on a personality name and the like. The management information, on the corner of a piece of music, such as the music 1 information 204 contains information on a musical name, an artist name, a name of a recorded album, a genre of a piece of music, and the like. Moreover, the information on the corners contains time information as well representing time zones, in the program, in which the corners are broadcasted, respectively.

Since the management information on the corners contains the time information described above, it is made correspond to the corners in the sound file 100, respectively. More specifically, the opening 102 portion, the talk 1 (103) portion, the music 1 (104) portion, and the ending 109 portion of the sound file 100 are made correspond to the opening information 202, the talk 1 information 203, the music 1 information 204, and the ending information 209, respectively. For this reason, any one of the corners is selected in accordance with the management information, whereby the sound of the corner concerned as a part of the sound file 100 as one data can be selected, thereby reproducing only the sound thus selected from its start position.

For example, it is assumed that a piece of music having a musical name of “ABCDE” was broadcasted in the corner of the music 1 (104) as one corner. When the user intends to reproduce only this piece of music by referring to the list, since the music information 204 corresponding to this piece of music contains the information on the start position and end portion of this piece of music, it becomes possible to reproduce only a portion, within the sound file 100, which is specified by the start position and end position concerned.

At that, the sound file 100 and the management information data 200 may be stored in the form of the different files, or may be stored collectively in the form of one file.

FIGS. 5A and 5B show display examples in the displaying portion 19 when the musical program recorded with the broadcasting program-reproducing apparatus 1 is reproduced. That is, FIG. 5A is a display example of a list of the recorded programs, and FIG. 5B is a display example of a list of names of pieces of music contained in the selected program.

When the user reproduces the program which is previously recorded with sound, firstly, a monitor 191 displays thereon the list of all the recorded programs. Program titles are extracted from the header information 201 of the management information data 200 corresponding to the sound files, respectively, stored in the internal storing portion 16 or the external storing portion 22, and displayed on the monitor 191.

For example, when it is assumed that four programs having program A data 401, program B data 402, program C data 403, and program D data 404 is stored as the recorded programs in the internal storing portion 16, as shown in FIG. 5A, the monitor 191 displays thereon the information on the four programs in the form of a list.

Reference numbers 411 allocated to the respective programs, channel numbers 412 with which the respective programs were broadcasted, the dates 413 of broadcastings, program names 414, and the like are displayed in the form of the respective program data in the list. The user moves a cursor 415 up to the display position of the program data of a desired program by referring to the program data, thereby selecting the desired program.

When the user selects one program (e.g., the program B 402) from the list displayed on the monitor 191, there is displayed a programme list contained in the sound list of the program B as shown in FIG. 5B.

The program B data 402 is displayed on an upper area on the screen of the monitor 191, which represents that the program selected by the user is the program B. In addition, a programme list 410 is displayed on an area under that upper area on the screen of the monitor 191. Music order numbers 416, and musical names 417 are displayed as the respective data of the programme list 410. It should be noted that artist names may be displayed instead of the musical names or both of the artist names and the musical names may also be displayed.

However, all the corners constituting the program do not necessarily consist of pieces of music. Thus, the program composition, as shown in FIG. 4, contains the talk by the personality, the opening, the ending, etc. Hence, in this case, no musical name is displayed. Thus, as shown in FIG. 5B, the display representing the corner other than the music is made, or the blank is displayed.

The user moves the cursor 415 up to a display position of a desired musical name in the programme list 410 displayed on the monitor 191, whereby the desired piece of music is selected and started to be reproduced.

With the construction as described above, even when a plurality of pieces of music are contained in one file having the broadcasting program recorded therein, it is possible to know the pieces of music contained in the one file. In addition, it is possible to reproduce only the desired piece of music without requiring the operation for the rapid feed or rewind.

(Retrieval of Music)

With the broadcasting program-reproducing apparatus 1 according to the present invention, only the piece of music to which the user desires to listen can be retrieved from all the pieces of music which were broadcasted in a plurality of programs which were recorded with sound and stored to be extracted, and can be reproduced.

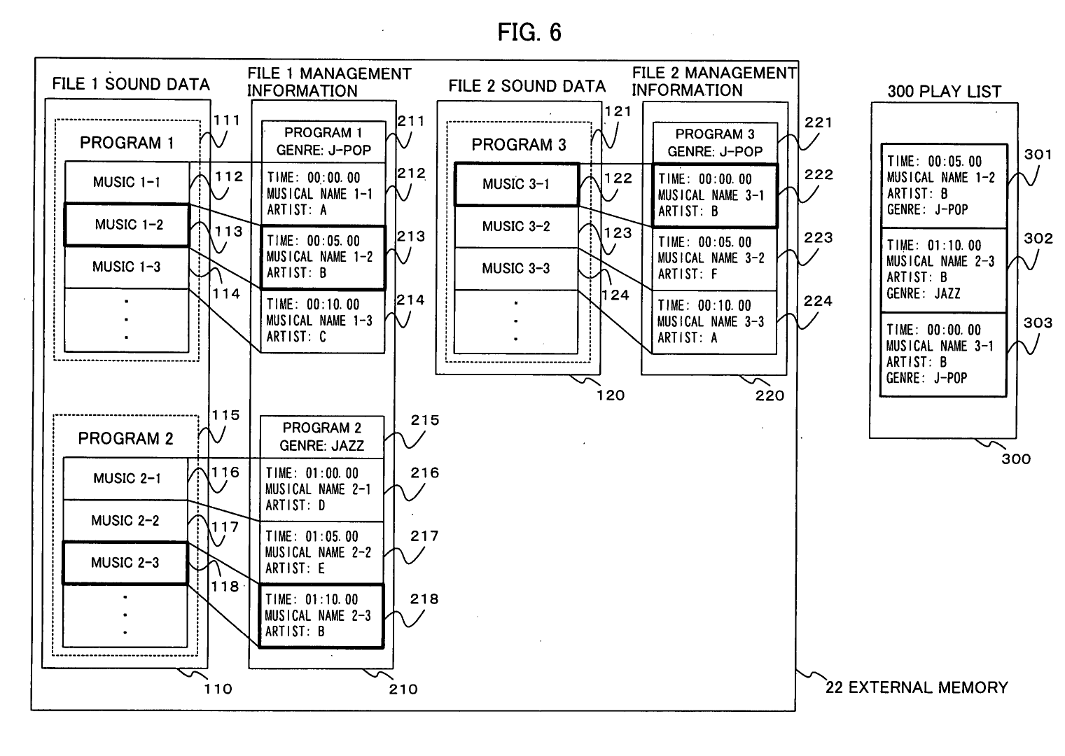

FIG. 6 is a diagram showing a situation in which only a desired piece of music is extracted from a plurality of broadcasting program data.

For example, it is assumed that file 1 sound data 110 and file 1 management information 210 corresponding thereto, and file 2 sound data 120 and file 2 management information 220 corresponding thereto are stored in the memory card as the external memory 22.

Two programs consisting of a program 1 (111) and a program 2 (115) is contained in the file 1 sound data 110. Three pieces of music consisting of music 1-1 (112), music 1-2 (113), and music 1-3 (114) are broadcasted in the program 1 (111). In addition, three pieces of music consisting of the music 2-1 (116), music 2-2 (117), and music 2-3 (118) are broadcasted in the program 2 (115).

Header information 211 of the program 1, information 212 on the music 1-1, information 213 on the music 1-2, information 214 on the music 103, header information 215 of the program 2, information 216 on the music 2-1, information 217 on the music 2-2, and information 218 on the music 2-3 are contained in the file 1 management information 210 corresponding to the file 1 sound data 110.

In addition, a program 3 (121) is contained in the file 2 sound data 120. Three pieces of music consisting of the music 3-1 (122), music 3-2 (123), and music 3-3 (124) are broadcasted in the program 3 (121). Header information 221 of the program 3, information 222 on the music 3-1, information 223 on the music 3-2, and information 224 on the music 3-3 are contained in the file 2 management information 220 corresponding to the file 2 sound data 120.

When the user retrieves pieces of music of an artist “B” from all the musical programs which are stored in the external memory 22, in FIG. 6, it is understood from the corresponding file 1 management information 210 and the corresponding file 2 management information 220 that the pieces of music of the artist “B” are the music 1-2 (113) in the program 1, the music 2-3 (118) in the program 2, and the music 3-1 (122) in the program 3. Thus, the three pieces of music are extracted, and a play list 300 is generated.

Detailed information 301 corresponding to the music 1-2 (113) in the program 1, detailed information 302 corresponding to the music 2-3 (118) in the program 2, and detailed information 303 corresponding to the music 3-1 (122) in the program 3 are contained in the play list 300. For these pieces of detailed information 301, 302 and 303, the necessary information is selected from the management information corresponding to the pieces of music and the header information, of the programs, containing the information on the pieces of music concerned. For example, it is assumed that start time, the musical names, and the artist names are contained in the management information on each piece of music, and a genre name of music which is introduced in the program concerned is contained in the. header information. The start time, the musical names and the artist names, and the genre names are selected as the detailed information on the pieces of music on the play list 300 from the management information, and the header information, respectively, thereby constructing the detailed information for the play list.

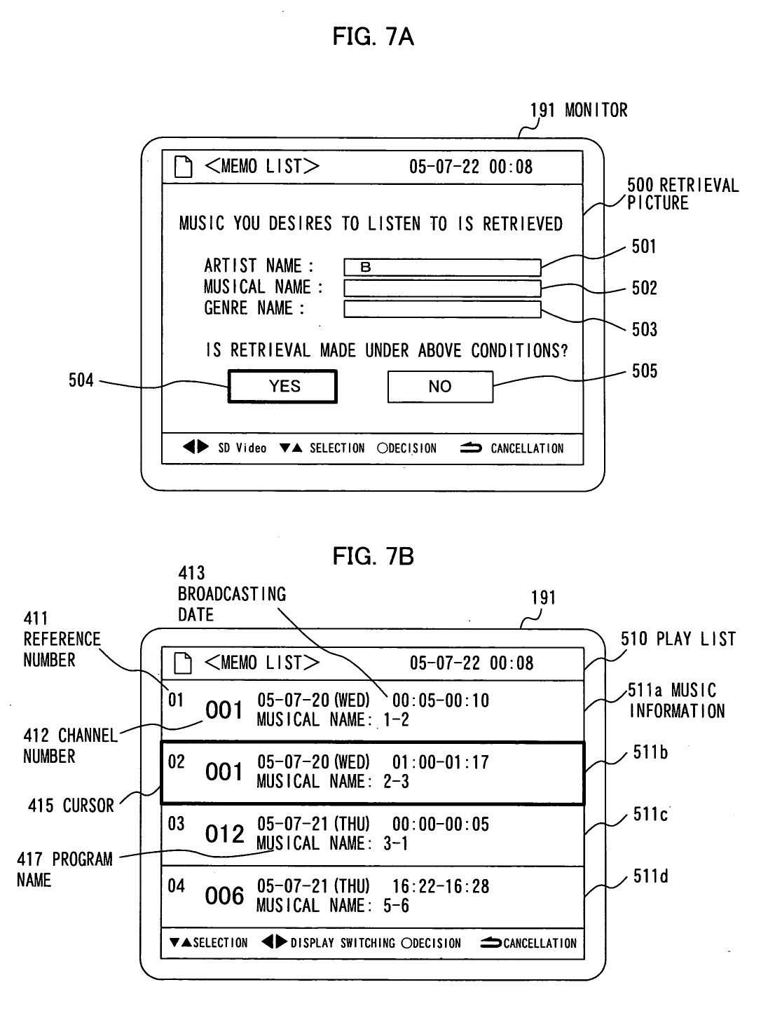

FIGS. 7A and 7B are respectively display examples of images during the music retrieval. That is to say, FIG. 7A is a display example of a retrieval picture, and FIG. 7B is a display example of a play list after completion of the retrieval.

When the user starts an operation for music retrieval, as shown in FIG. 7A, the monitor 191 displays thereon a retrieval picture 500 through which the retrieval contents are inputted. An artist name input cell 501, a musical name input cell 502, and a genre name input cell 503 are displayed on the picture. The user inputs retrieval conditions to these cells 501, 502, and 503. When the user inputs a condition to at least one of the three cells 501, 502, and 503, and selects a “YES” button 504, the retrieval is started under these conditions. When the user inputs the input contents by mistakes and re-inputs the proper contents, he/she selects a “NO” button 505.

As regards an input method, for example, there is a method in which the user instructs the monitor 191 to display thereon a character input pad or the like, and he/she selects characters on a character by character basis to input the retrieval conditions. Alternatively, an external input unit such as a keyboard can be connected to the broadcasting program-reproducing apparatus 1 in order to input the retrieval conditions. In addition, it is also possible that the contents of the items are displayed from the list, on all the pieces of music, which is previously stored, and the user is caused to select the necessary information from among the displayed contents on all the pieces of music.

When the user selects “B” as the artist name, and starts the retrieval, the retrieval results are displayed in the form of a play list as shown in FIG. 7B.

In FIG. 7B, the monitor 191 displays thereon a play list 510. A plurality of pieces of music information 511a, 511b, 511c and 511d on the extracted pieces of music are displayed in the play list 510. A reference number 411, a channel number 412, the broadcasting date 413, a musical name 417, and the like are displayed as each of the pieces of music information.

The user moves the cursor 415 up to the display position of the desired piece of music information in the play list 510 displayed on the monitor 191, whereby the desired piece of music is selected and started to be reproduced.

With the construction as described above, the user can retrieve the piece of music which is to his/her taste from a plurality of recorded musical programs, and can reproduce only the piece of music thus retrieved.

(Error Correction of Start Time)

As described above, the data on the start time and end time of the program, and the data on the start time and end time of each corner are contained in the management information. However, an error of several seconds is recognized between the time on the data and the actual broadcasting time from a specification on the broadcasting station side. For this reason, when no error is corrected, the nonconformity is caused such that the heads of all the pieces of music are cut or the ends of all the pieces of music are interrupted.

With the broadcasting program-reproducing apparatus 1 according to the present invention, the error in such a case is adjusted to adjust the start time on the data and the actual start time to each other, whereby the piece of music can be prevented from being interrupted halfway.

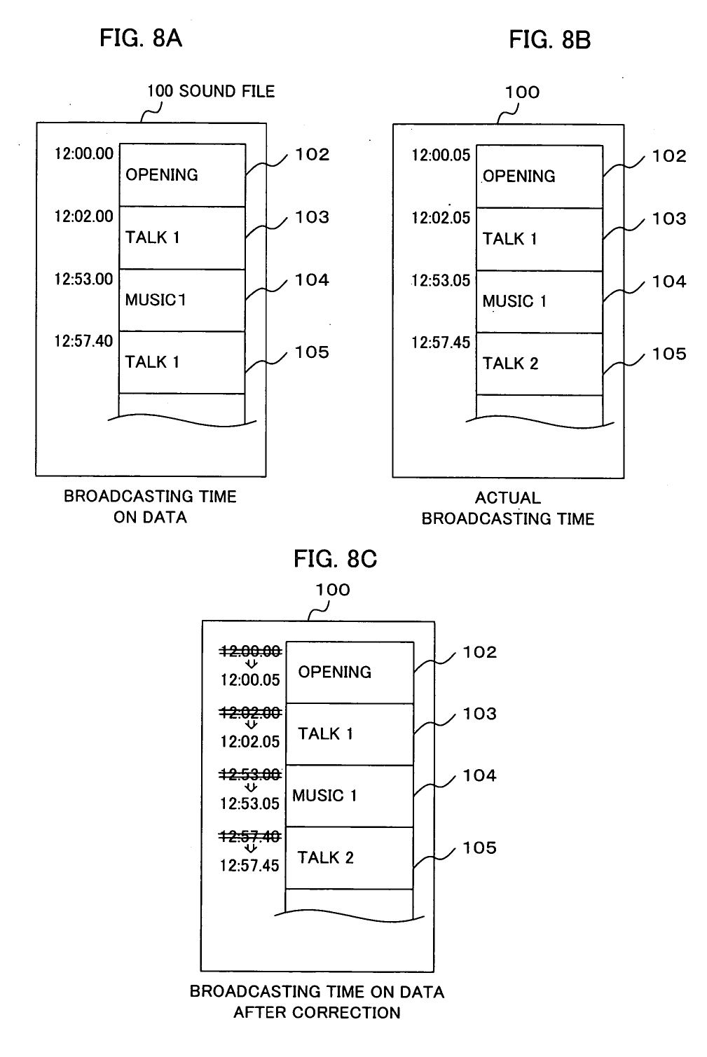

FIGS. 8A, 8B and 8C are respectively diagrams showing a situation in which an error occurring between the time on the management data and the actual broadcasting time is adjusted.

FIG. 8A is a diagram showing start time of each corner, on the management data, in the program recorded in the sound file 100. In this program, the opening 102 was started at 12:00.00. In the following, the talk 1 (103), the music 1 (104), and the talk 2 (105) were started at 12:02.00, 12:53.00, and 12:57.40, respectively.

On the other hand, FIG. 8B is a diagram showing actual start time or the like in the program concerned. It is assumed that this program was broadcasted five seconds as a whole behind time with respect to information on the management data. That is to say, the opening 102 was stated from 12:00.05. In the following, the talk 1 (103), the music 1 (104), and the talk 2 (105) were started at 12:02.05, 12:53.05, and 12:57.45, respectively.

Thus, when the user reproduces the sound of the desired corner in accordance with the management data, excessive sound is reproduced for the head of five seconds and the sound corresponding to the last five seconds is lacked.

Then, the adjustment is performed through the operation made by the user so that the time on the management data is entirely delayed by five seconds, whereby as shown in FIG. 8C, each start time on the management data is delayed by five seconds, and thus the reproduction can be made exactly at the appointed time.

The user adjusts the time using the operation portion 6 in accordance with the displayed contents on the monitor 191.

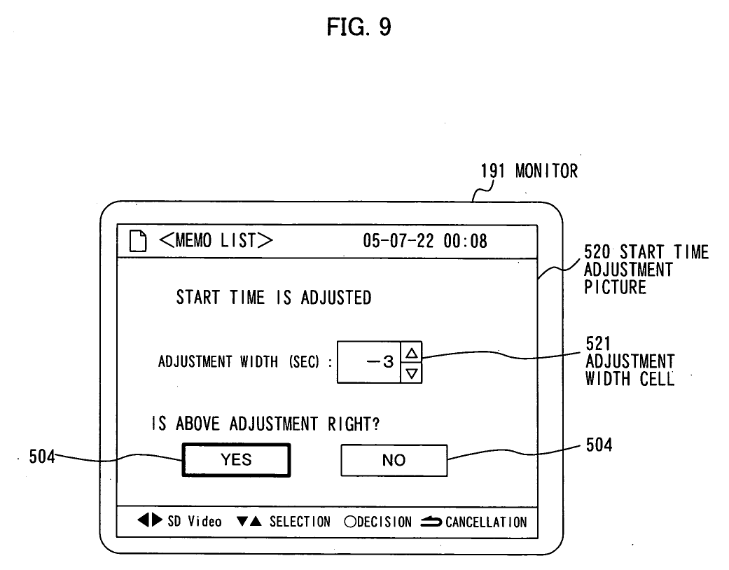

FIG. 9 is a display example of an image during the adjustment of the start time. When the user starts an operation for adjusting the start time, as shown in FIG. 9, the monitor 191 displays thereon a start time adjustment picture 520 to which the user inputs the retrieval contents. An adjustment width input cell 521 is displayed on the picture, and the user inputs information on an adjustment width to the adjustment width input cell 521. When the user inputs the information on the adjustment width and selects a “YES” button 504, the start time is adjusted under this condition. When intending to cancel the adjustment, the user selects a “NO” button 505.

With the construction as described above, even when an error occurs between the actual broadcasting time and the time on the management data from the specification on the broadcasting station side, the error is adjusted, thereby allowing the pieces of music to be reproduced from their head portions.

What is claimed is:

1. A broadcasting program-reproducing apparatus comprising:
a receiving portion for receiving a broadcasting program of an image or a sound, and management information corresponding to events constituting the broadcasting program;
a storing portion for storing therein the broadcasting program and the management information;
a determining portion for determining start positions and end positions of the events in the storing portion in accordance with the management information stored in the storing portion;
a list-generating portion for extracting a predetermined event from the events in the broadcasting program in accordance with the start positions and the end positions of the events to generate a play list; and
a reproducing portion for reproducing the predetermined event thus extracted in accordance with the play list.

2. A broadcasting program-reproducing apparatus according to claim 1, wherein:
the receiving portion receives the broadcasting program containing music as the event, and the management information containing at least one piece of information on names of the music, artist names, and broadcasting time as the events.

3. A broadcasting program-reproducing apparatus according to claim 2, wherein:
the reproducing portion extracts music of a predetermined artist name selected from the artist names in accordance with a plurality of broadcasting programs and a plurality of pieces of management information, and reproduces the music thus extracted.

4. A broadcasting program-reproducing apparatus according to claim 1, wherein:
the storing portion includes a first file in which the broadcasting program is stored, and a second file in which the management information is stored.

5. A broadcasting program-reproducing apparatus according to claim 1, wherein:
the determining portion shifts the start positions of the events forward or rearward by a predetermined position.
